(19) United States
(12) Patent Application Publication
(10) Pub. No.: US 2024/0306759 A1
(43) Pub. Date: Sep. 19, 2024

(54) Illuminant shoe

(71) Applicant: Fang HUANG, Hunan (CN)

(72) Inventor: Fang HUANG, Hunan (CN)

(21) Appl. No.: 18/129,079

(22) Filed: Mar. 31, 2023

(30) Foreign Application Priority Data
Mar. 17, 2023 (CN) 2023205410670

(51) Int. Cl. A43B 3/36; F21V 23/00; F21V 23/04

(52) U.S. Cl. CPC A43B 3/36; F21V 23/003; F21V 23/04; F21Y 2103/10; F21Y 2115/10

(57) ABSTRACT

A novel illuminant shoe including a bottom made of supercritical foaming EVA, and an illuminant assembly including an LED light strip, a main control circuit board and a power supply; the LED light strip is electrically connected to the main control circuit board ; the main control circuit board is connected to a control switch via a second connector; the control switch is provided with a power charging interface. The LED light strip may be conveniently removed from the bottom for maintenance. As the first and the second connector are each formed by male plug and female socket, the LED light strip and the control switch may be conveniently disconnected from the main control circuit board, thereby increasing the maintenance or replacement efficiency. As the bottom is made of supercritical foaming EVA, the LED light strip exhibits more even and softer lighting and better multicolor effect.

### FIELD OF THE INVENTION

The present invention relates to the technical field of footwear and more particularly pertains to a novel illuminant shoe.

### BACKGROUND OF THE INVENTION

Along with social development, people are increasingly appreciative of the aesthetics and comfort of footwear. When ordinary consumers purchase various products, not only do they require conventional functionalities, but also they desire other additional functionalities. As a result, footwear which is illuminant and capable of playing music are available in the marketplace.

Illuminant footwear available in the marketplace may take reference from an illuminant shoe disclosed in the Chinese invention patent CN104161341B. By providing a supporting bar in a light strip casing to support a flexible circuit board, the flexible circuit board is positioned in the casing, thereby resulting in neat alignment of the light sources on the flexible circuit board; as a result, the flashing direction is kept uniform, thereby enhancing the visual effect when the illuminant shoe flashes and improving the aesthetics of the illuminant shoe.

The aforementioned prior art may be further improved by optimizing the connection between the light strip and the power supply as well as the connection between the control switch and the power supply, so as to increase maintenance efficiency.

### BRIEF SUMMARY OF THE INVENTION

The present invention provides a novel illuminant shoe to overcome the aforementioned shortcomings.

To attain this, the present invention provides a novel illuminant shoe comprising a bottom, an upper, an insole and an illuminant assembly; the upper is adhered or sewn to an upper end of the bottom; the insole is detachably laid on the bottom; the bottom is provided with a limiting cavity in which the illuminant assembly is embeddedly mounted; the illuminant assembly comprises an LED light strip, a main control circuit board and a power supply; the LED light strip is electrically connected to the main control circuit board via a first connector; the main control circuit board is connected to a control switch via a second connector; the first connector and the second connector are each formed by cooperative male plug and female socket; the control switch is provided with a power charging interface.

Furthermore, the limiting cavity comprises an annular groove for receiving the LED light strip and a limiting groove for receiving the LED light strip and the power supply; a channel is provided on a first side of the limiting groove for connecting with the annular groove; the annular groove is disposed along a perimeter of the bottom.

Furthermore, the LED light strip comprises a flexible circuit board and a plurality of LED light sources disposed on the flexible circuit board; each of the LED light sources is enclosed by an oval plastic casing disposed on the flexible circuit board.

Furthermore, a plastic outer casing encloses the LED light strip and the power supply.

Furthermore, a position-limiting sleeve is provided on the upper for receiving the control switch.

Furthermore, the control switch is mounted on the upper via an elastic buckle at a lower end thereof

The beneficial effects of the present invention are as follows: As the illuminant assembly is embeddedly mounted in the limiting cavity, the LED light strip may be conveniently removed from the bottom for maintenance. Besides, as the first connector and the second connector are each formed by male plug and female socket, the LED light strip and the control switch may be conveniently disconnected from the main control circuit board, thereby increasing the maintenance or replacement efficiency of the LED light strip or the control switch.

### BRIEF DESCRIPTION OF THE DRAWINGS

FIG. 1 shows a perspective view of the present invention;

FIG. 2 shows a top view of the bottom of the present invention;

FIG. 3 shows a sectional view of the bottom of the present invention.

FIG. 4 shows an enlarged view of the portion marked “A” in FIG. 3.

FIG. 5 shows the male plug and female socket of the present invention.

FIG. 6 shows the illuminant assembly of the present invention.

FIG. 7 shows a perspective view of the second embodiment.

As illustrated in the figures: 1 denotes the bottom; 1A denotes the limiting cavity; 101 denotes the annular groove; 102 denotes the limiting groove; 103 denotes the channel; 2 denotes the upper; 3 denotes the LED light strip; 4 denotes the wire; 5 denotes the power supply; 6 denotes the first connector; 7 denotes the second connector; 8 denotes the control switch; 9 denotes the power charging interface; 10 denotes the flexible circuit board; 11 denotes the LED light sources; 12 denotes the oval plastic casing; 13 denotes the plastic outer casing; 14 denotes the elastic buckle; 15 denotes the main control circuit board; 16 denotes the insole; 17 denotes the illuminant assembly; 18 denotes the male plug; 19 denotes the female socket; 20 denotes the position-limiting sleeve.

### DETAILED DESCRIPTION OF THE INVENTION

The present invention will be described in detail with reference to the accompanying drawings and preferred embodiments.

### Embodiment 1

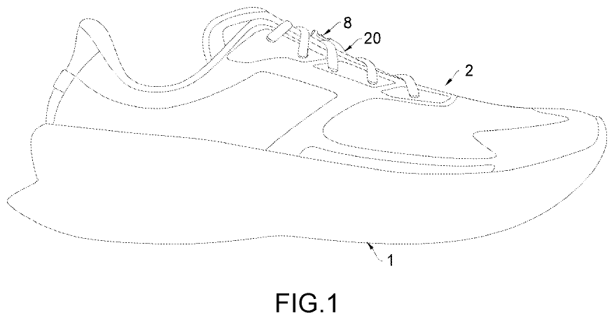

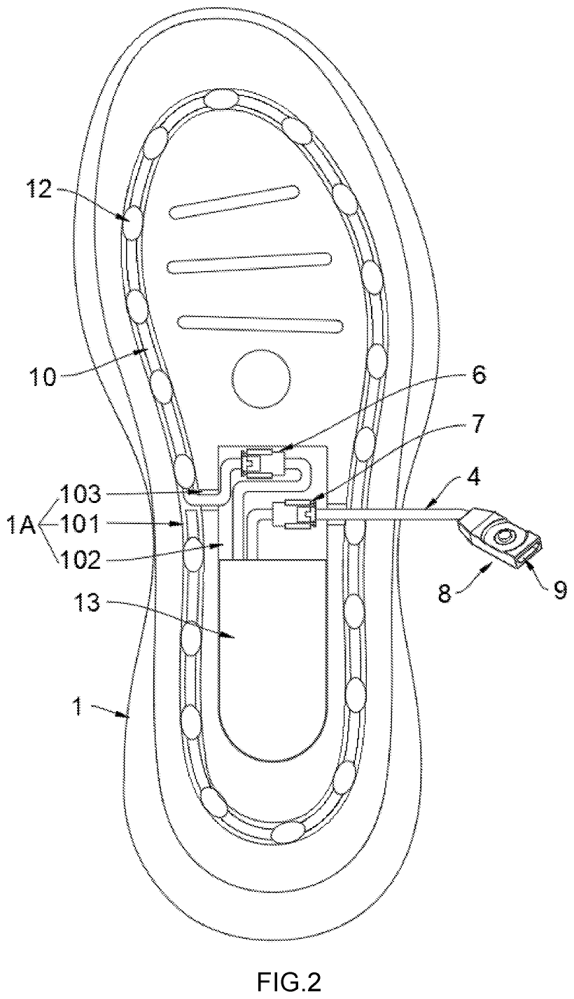

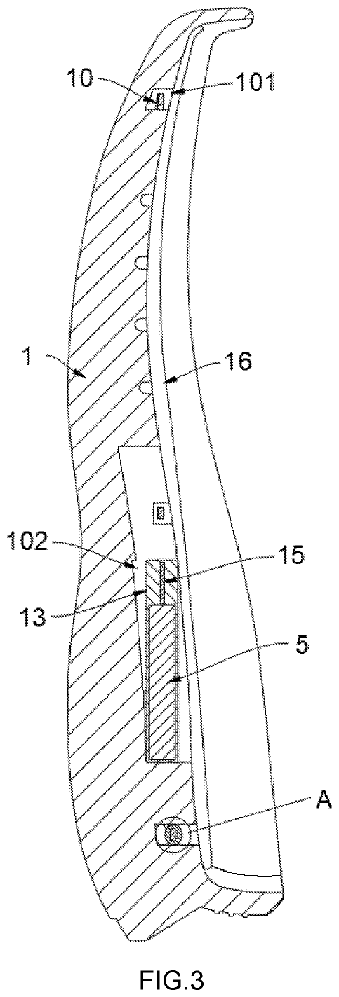

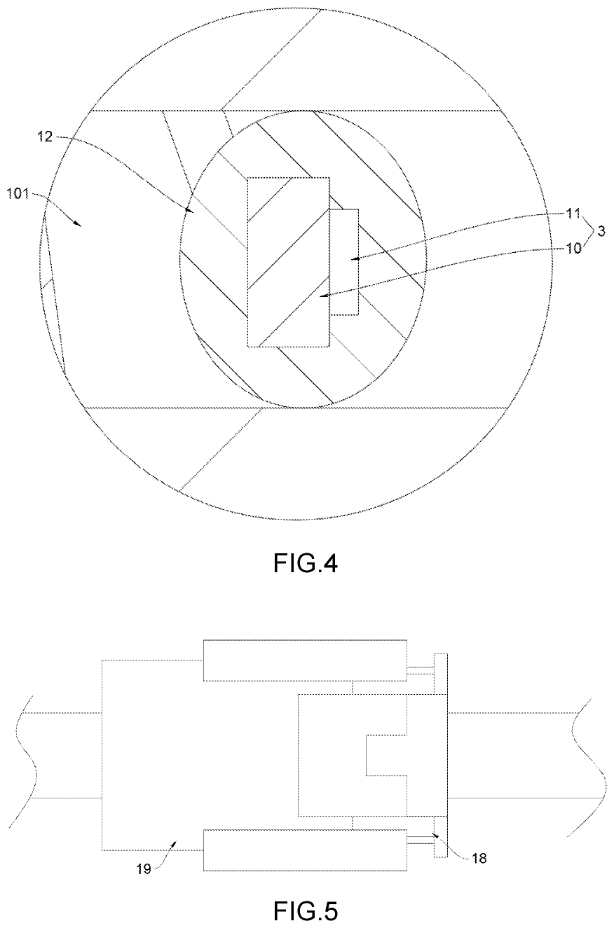

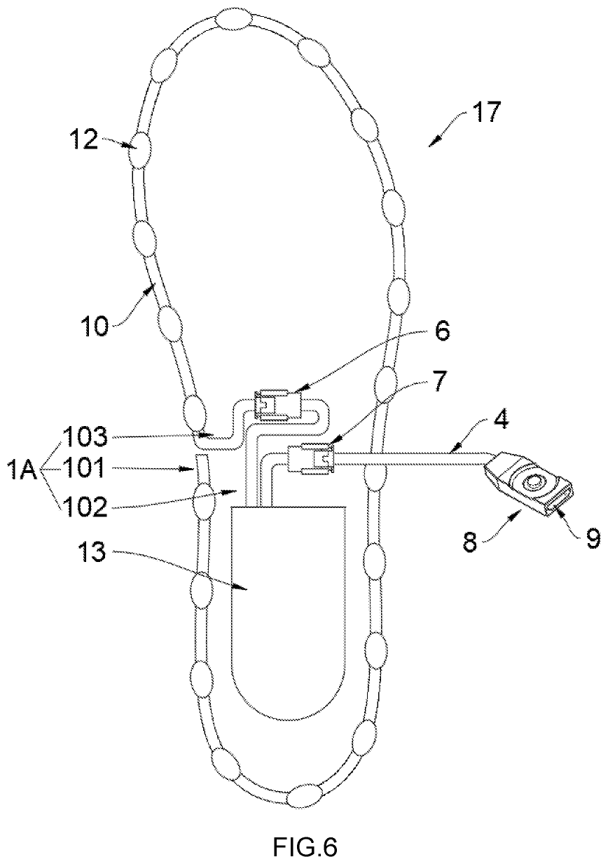

In the present embodiment, as illustrated in FIGS. 1-6, a novel illuminant shoe comprises a bottom 1, an upper 2, an insole 16 and an illuminant assembly 17. The upper 2 is adhered or sewn to an upper end of the bottom 1. The insole 16 is detachably laid on the bottom 1. The bottom 1 is provided with a limiting cavity 1A in which the illuminant assembly 17 is embeddedly mounted. The illuminant assembly 17 comprises an LED light strip 3, a main control circuit board 15 and a power supply 5. The LED light strip 3 is electrically connected to the main control circuit board 15 via a first connector 6. The main control circuit board 15 is connected to a control switch 8 via a second connector 7. The first connector 6 and the second connector 7 are each formed by cooperative male plug 18 and female socket 19. The control switch 8 is provided with a power charging interface 9. The power charging interface 9 is electrically connected to an external power source for charging the power supply 5. The power charging interface 9 is a Micro USB interface; furthermore, the power charging interface 9 could also be a Type-C interface.

The limiting cavity 1A comprises an annular groove 101 for receiving the LED light strip 3 and a limiting groove 102 for receiving the LED light strip 3 and the power supply 5. A channel 103 is provided on a first side of the limiting groove 102 for connecting with the annular groove 101. The annular groove 101 is disposed along a perimeter of the bottom 1.

The LED light strip 3 comprises a flexible circuit board 10 and twenty LED light sources 11 disposed on the flexible circuit board 10. Each of the LED light sources 11 is enclosed by an oval plastic casing 12 disposed on the flexible circuit board 10. A plastic outer casing 13 encloses the LED light strip 3 and the power supply 5. The oval plastic casing 12 and the plastic outer casing 13 which respectively enclose the LED light sources 11 and the LED light strip 3 and the power supply 5 are used to increase water resistance and overall strength, and decrease the damage probability.

The oval plastic casing 12 and the plastic outer casing 13 are made of transparent polyvinyl chloride (PVC) materials.

In the present embodiment, the illuminant shoe is a sports shoe. A position-limiting sleeve 20 is provided on the upper 2 for receiving the control switch 8. The position-limiting sleeve 20 is provided in a middle portion of a shoe tongue. The control switch 8 is electrically connected to the main control circuit board 15 via a wire 4 which extends along an inner wall of the upper 2 to the bottom 1. The inner wall of the upper 2 is provided with fixing sleeve or fixing ring for limiting the wire 4, which effectively prevents the wire 4 from moving around freely inside the shoe and thus affecting the user. The fixing sleeve and the fixing ring are respectively made of flexible wires and flexible fabrics.

As the illuminant assembly 17 is embeddedly mounted in the limiting cavity 1A, the LED light strip 3 may be conveniently removed from the bottom 1 for maintenance. Besides, as the first connector 6 and the second connector 7 are each formed by male plug 18 and female socket 19, the LED light strip 3 and the control switch 8 may be conveniently disconnected from the main control circuit board 15, thereby increasing the maintenance or replacement efficiency of the LED light strip 3 or the control switch 8.

### Embodiment 2

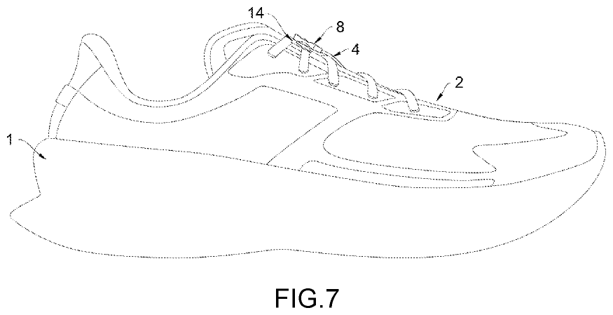

In this embodiment, as illustrated in FIG. 7, it differs from Embodiment 1 in that the control switch 8 is mounted on the upper 2 via an elastic buckle 14 at a lower end thereof. When in use, the elastic buckle 14 is usually snapped on the shoelace.

The aforementioned only constitutes preferred embodiments of the present invention and should not be considered as limiting the present invention in any way. Although the present invention is disclosed by means of the aforementioned preferred embodiments, the aforementioned preferred embodiments are not intended to limit the present invention. Those skilled in the art may make equivalent changes and modifications based on the present disclosure without departing from the scope of the present invention. Any simple changes and equivalent variations and modifications made to the aforementioned embodiments without departing from the essence of the present invention shall also fall within the protection scope of the present invention.

1. A novel illuminant shoe comprising a bottom, an upper, an insole and an illuminant assembly; the upper is adhered or sewn to an upper end of the bottom; the insole is detachably laid on the bottom; characterized in that the bottom is provided with a limiting cavity in which the illuminant assembly is embeddedly mounted; the illuminant assembly comprises an LED light strip, a main control circuit board and a power supply; the LED light strip is electrically connected to the main control circuit board; the bottom is made of supercritical foaming EVA.

2. The novel illuminant shoe as in claim 1, characterized in that the limiting cavity comprises an annular groove for receiving the LED light strip and a limiting groove for receiving the LED light strip and the power supply; a channel is provided on a first side of the limiting groove for connecting with the annular groove; the annular groove is disposed along a perimeter of the bottom.

3. The novel illuminant shoe as in claim 1, characterized in that the LED light strip comprises a flexible circuit board and a plurality of LED light sources evenly disposed on the flexible circuit board; each of the LED light sources is enclosed by an oval plastic casing disposed on the flexible circuit board.

4. The novel illuminant shoe as in claim 1, characterized in that a plastic outer casing encloses the LED light strip and the power supply.

5. The novel illuminant shoe as in claim 1, characterized in that the LED light strip is electrically connected to the main control circuit board via a first connector; the main control circuit board is connected to a control switch via a second connector.

6. The novel illuminant shoe as in claim 5, characterized in that the first connector and the second connector are each formed by cooperative male plug and female socket.

7. The novel illuminant shoe as in claim 5, characterized in that the control switch is provided with a power charging interface.

8. The novel illuminant shoe as in claim 5, characterized in that a position-limiting sleeve is provided on the upper for receiving the control switch.

9. The novel illuminant shoe as in claim 5, characterized in that the control switch is mounted on the upper via an elastic buckle at a lower end thereof.
